(19) United States
(12) Patent Application Publication
(10) Pub. No.: US 2025/0157357 A1
(43) Pub. Date: May 15, 2025

(54) Folding Learning Block with Variable Structure Panels

(71) Applicants: Timothy Wade, Early, TX (US); Kaitlan Wade, Early, TX (US)

(72) Inventors: Timothy Wade, Early, TX (US); Kaitlan Wade, Early, TX (US)

(21) Appl. No.: 18/946,685

(22) Filed: Nov. 13, 2024

Related U.S. Application Data
(60) Provisional application No. 63/548,426, filed on Nov. 14, 2023.

(51) Int. Cl. G09B 19/00; A63H 33/00

(52) U.S. Cl. CPC G09B 19/00; A63H 33/00

(57) ABSTRACT

A folding learning block may generally comprise four structure panels, each supported by a structure wire and coupled together to form four lateral sides of a cube. Two collapsable panels may be coupled to the structure panels to form a cube. For example, a top panel may be coupled to the four lateral panels to form a top side of the cube, and a bottom panel may be coupled to the four lateral panels to form a bottom side of the cube. The bottom panel may have a hole. The top panel and the bottom panel may be collapsable while the structure wire maintains a shape of the four lateral panels.

### PRIORITY CLAIM

This application claims the benefit of priority of U.S. Provisional Patent Application Ser. No. 63/548,426 titled “FOLDING LEARNING BLOCK WITH VARIABLE STRUCTURE PANELS”, filed on Nov. 14, 2023, whose inventor(s) is/are Timothy Wade and Kaitlan Wade, which is hereby incorporated by reference in its entirety as though fully and completely set forth herein.

### BACKGROUND

### 1. Field of the Invention

The present invention relates generally to learning toys, and more specifically to a folding learning block with variable structure panels.

### 2. Description of Related Art

There is always a need for different kinds of learning toys to provide a fun learning experience. Conventional learning toys can take up too much storage space. There is a need for a folding learning block with variable structure panels which can utilize minimal storage space.

Accordingly, although great strides have been made in the area of learning toys, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is an isometric view of the bottom of a folding learning block with variable structure panels according to the disclosed embodiments of the present invention;

FIG. 2 is an isometric view of the top view of the folding learning block with variable structure panels of FIG. 1;

FIG. 3 includes auxiliary views of the folding learning block with variable structure panels of FIG. 1.

While the folding learning block with variable structure panels and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed. On the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the folding learning block with variable structure panels and the method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcome one or more of the above-discussed problems commonly associated with conventional learning toys. Specifically, the folding learning block with variable structure panels of the present application utilizes minimal storage space. These and other unique features of the system and method of use are discussed below and illustrated in the accompanying drawings.

The folding learning block with variable structure panels and method of use will be understood, both as to its structure and operation, from the accompanying drawings, taken in conjunction with the accompanying description. Several embodiments of the device are presented herein. It should be understood that various components, parts, and features of the different embodiments may be combined and/or interchanged with one another, all of which are within the scope of the present application, even though not all variations and particular embodiments are shown in the drawings. It should also be understood that the mixing and matching of features, elements, and/or functions between various embodiments are expressly contemplated herein so that one of ordinary skill in the art would appreciate from this disclosure that the features, elements, and/or functions of one embodiment may be incorporated into another embodiment as appropriate unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

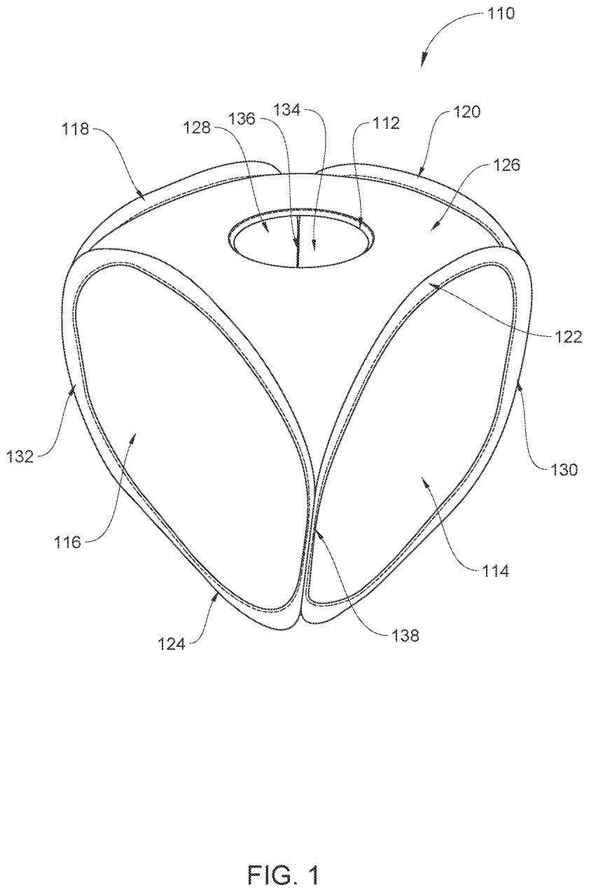

Referring now to the drawings wherein reference characters identify corresponding or similar elements throughout the several views, FIGS. 1-3 depict different views of a folding learning block with variable structure panels in accordance with a preferred embodiment of the present application. It will be appreciated that a folding learning block with variable structure panels overcomes one or more of the above-listed problems commonly associated with conventional learning toys. In addition, it should be appreciated that more or fewer of such components may be included in different embodiments of the folding learning block with variable structure panels.

Some embodiments of the folding learning block may generally comprise four structure panels, each supported by a structure wire and coupled together to form four lateral sides of a cube. Two collapsable panels may be coupled to the structure panels to form a cube. For example, a top panel may be coupled to the four lateral panels to form a top side of the cube, and a bottom panel may be coupled to the four lateral panels to form a bottom side of the cube. The bottom panel may have a hole. The top panel and the bottom panel may be collapsable while the structure wire maintains a shape of the four lateral panels. In more specific embodiments, such as the example of FIGS. 1-3, an apparatus 110 with variable structure panels comprises panel 1 134, which is formed to shape using structure wire 1 120. Panel 1 134 is connected to panel 2 114 using stitching along folding edge 3 130. Panel 2 114 a formed to shape using structure wire 2 122. Connected to panel 2 114 is Panel 3 116 using stitching along folding edge 4 138. Each panel is sewn around the edge to enclose the structure wire that supports each panel.

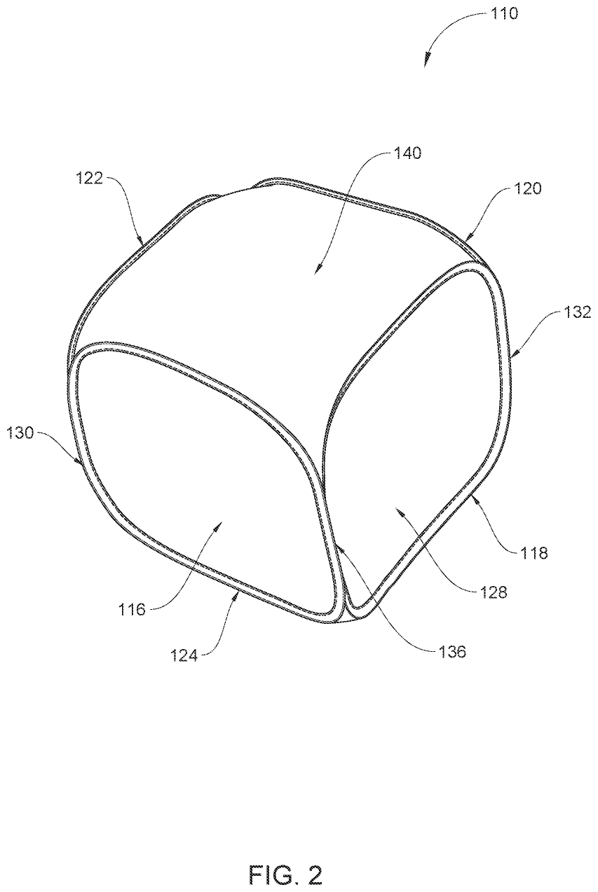

Panel 3 116 is formed to shape using structure wire 3 124. Panel 3 116 is connected to panel 4 128 using stitching along folding edge 1 132. Panel 4 128 is formed to shape using structure wire 4 118. Panel 6 126 is connected to panel 1 134, panel 2 114, panel 3116, and panel 4 128 by way of sewing. Panel 6 126 is located at the bottom of apparatus 110. Panel 6 126 of FIGS. 1-3 has a hole 112. The size and shape of the hole 112 may vary to prevent restriction of airflow when opening or closing the apparatus 110. In some examples, it may be advantageous for the hole 112 to be a circle having a diameter of about 4 inches. In some examples, the hole 112 may comprise or be covered by a mesh suitable for allowing sufficient airflow when opening or closing the apparatus 110. Hole 112 may have stitching around the edge. Panel 5 140 is located on the top of apparatus 110 and is connected to panel 4 128, panel 3 116, panel 2 114, and panel 1 134 by sewing, see FIG. 1-FIG. 2.

The entire apparatus 110 can collapse into itself by pressing together folding edge 2 136 and folding edge 4 138 or folding edge 1 and folding edge 3, the apparatus 110 will begin to collapse and the folding edges will correctly align to create a flat square for length and width while panel 5 140 and panel 6 126 are at the top and bottom. No structure wire is included in panel 5 140 and panel 6 126 to allow them to not restrict folding edge 1 132, folding edge 2 136, folding edge 3 130, or folding edge 4 138.

Referring to FIG. 1, 110 is apparatus, 112 is hole, 114 is panel 2, 116 is panel 3, 118 is structure wire 4, 120 is structure wire 1, 122 is structure wire 2, 124 is structure wire 3, 126 is panel 6, 128 is panel 4, 130 is folding edge 3, 132 is folding edge 1, 134 is panel 1, 136 is folding edge 2, and 138 is folding edge 4.

Referring to FIG. 2, 110 is apparatus, 116 is panel 3, 118 is structure wire 4, 122 is structure wire 2, 124 is structure wire 3, 128 is panel 4, 130 is folding edge 3, 132 is folding edge 1, 136 is folding edge 2, and 140 is panel 5.

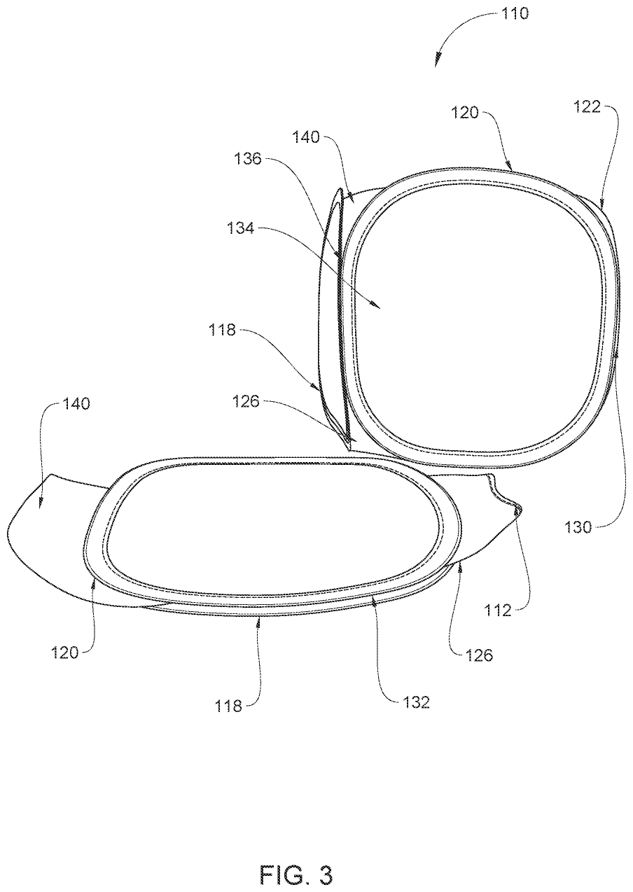

Referring to FIG. 3, 110 is apparatus, 112 is hole, 118 is structure wire 4, 120 is structure wire 1, 122 is structure wire 2, 126 is panel 6, 130 is folding edge 3, 132 is folding edge 1, 134 is panel 1, 136 is folding edge 2, and 140 is panel 5.

In the contemplated embodiment, the apparatus 110 with variable structure panels can be made of any suitable material, including but not limited to 100% polyester and steel.

In the contemplated embodiment, the apparatus 110 with variable structure panels can be made of any suitable sizes including but not limited to “Mini” size of 6 inches×6 inches×6 inches, “Original” size of 12 inches×12 inches×12 inches, “Jumbo” size of 18 inches×18 inches×18 inches.

In the contemplated embodiment, the apparatus 110 with variable structure panels can be made in such a way that four of the six panels have structure wire sewn in a way that encloses the steel wire. The two remaining panels are sewn in a way that connects the four panels with the structure wire. The top panel is smooth material, the bottom panel is sewn with a hole in the center. The hole is 4 inches in diameter.

In the contemplated embodiment, the apparatus 110 with variable structure panels can be made in any suitable colors including but not limited to solid-colored blocks without printing.

The example embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments but are amenable to various changes and modifications without departing from the spirit thereof.

What is claimed is:

1. A folding learning block comprising: six panels arranged to form a cube in a first state; a structural wire element embedded within four of said six panels to support the cube in the first state; and a hole in one of said panels, the hole configured to allow airflow during collapse of the cube to a second state, wherein two of said six panels lack said structural wire element, providing flexibility in folding and collapsing the cube to the second state.

2. The folding learning block of claim 1, wherein said structural wire element is strategically positioned within the four panels to provide stability and shape retention while allowing flexibility in folding.

3. The folding learning block of claim 1, wherein the hole is positioned in proximity to the structural wire elements, promoting enhanced airflow for improved ease of expansion and collapse.

4. The folding learning block of claim 1, wherein the structural wire elements within the four panels are seamlessly integrated into the panel material, ensuring durability and longevity of the folding learning block.

5. The folding learning block of claim 1, wherein the two panels lacking the structural wire elements are configured to facilitate easy folding and compact storage of the block, while maintaining structural integrity during use.

6. A method for manufacturing a folding learning block comprising: providing six panels, four of which include a structural wire element for shape retention; integrating the structural wire elements within the panel material; selectively omitting the structural wire elements from the remaining two panels to enhance flexibility in folding and collapsing the block; and incorporating a hole into one of the panels to facilitate airflow during expansion and contraction.

7. The method of claim 6, wherein the structural wire elements are sewn into the panel material, ensuring uniformity and strength in the integration process.

8. The method of claim 6, further comprising strategically positioning the hole in proximity to the structural wire elements to optimize airflow during the folding process.

9. The method of claim 6, wherein the folding learning block is designed for educational purposes, providing a versatile and interactive tool for learners of various ages.

10. A folding learning block, comprising: four structure panels, each supported by a structure wire and coupled together to form four lateral sides of a cube; a top panel coupled to the four lateral panels to form a top side of the cube; a bottom panel coupled to the four lateral panels to form a bottom side of the cube; and a hole in the bottom panel; wherein the top panel and the bottom panel are collapsable while the structure wire maintains a shape of the four lateral panels.

11. The folding learning block of claim 10, wherein the hole comprises a mesh.

12. The folding learning block of claim 10, further comprising a mesh covering the hole.
